(19) United States
(12) Patent Application Publication
(10) Pub. No.: US 2007/0068687 A1
(43) Pub. Date: Mar. 29, 2007

(54) Manually activated, portable fire-extinguishing aerosol generator having a plurality of discharge ports circumferentially disposed about the surface of the casing

(75) Inventor: Rudy M. Pavesi, Old Tappan, NJ (US)

Correspondence Address: SCHWEGMAN, LUNDBERG, WOESSNER & KLUTH, P.A., P.O. BOX 2938, MINNEAPOLIS, MN, 55402, US

(73) Assignee: FIREAWAY LLC, Minnetonka, MN (US)

(21) Appl. No.: 11/417,863

(22) Filed: May 4, 2006

Related U.S. Application Data
(63) Continuation-in-part of application No. 11/234,733, filed on Sep. 23, 2005.

(51) Int. Cl. A62C 13/22

(52) U.S. Cl. 169/84; 239/337; 239/338; 239/373

(57) ABSTRACT

Manually activated, portable aerosol fire extinguisher includes a casing having an outer circumferential surface, the casing having a plurality of discharge ports disposed in the outer circumferential surface. The extinguisher also includes an arrangement for generating fire suppression agent which is discharged through the discharge ports, and a manual activation system which enables manual activation of the generating arrangement at a safe location a distance from the fire. The activation system includes a firing pin which causes ignition of igniter material upon contact therewith (resulting in generation of the fire suppression agent), a handle which normally prevents the firing pin from contacting the igniter material and a manually releasable pull pin arranged to maintain the handle in a position preventing the firing pin from contacting the igniter material. Upon release of the pull pin, the handle is urged out of this position with the result that the firing pin contacts the igniter material, thereby causing generation of the fire suppression agent.

### CROSS-REFERENCE TO RELATED APPLICATION

The present application is a continuation-in-part of U.S. application Ser. No. 11/234,733 filed Sep. 23, 2005, the entire disclosure of which is incorporated herein by reference.

### FIELD OF THE INVENTION

The present invention relates generally to a fire-extinguishing aerosol generator and more specifically to a manually activated, portable fire-extinguishing aerosol generator designed to be thrown or otherwise introduced from a relatively safe location into a fire, which is preferably in an enclosed volume such as a room of a building, and to discharge a fire suppression agent therein to thereby extinguish the fire.

The present invention also relates to a method for extinguishing a fire in an enclosed volume using a portable aerosol generator.

### BACKGROUND OF THE INVENTION

Self-contained aerosol generators are often used to extinguish fires in enclosed volumes. The generators are usually mounted within the boundaries defining the enclosed volume and are typically automatically electronically activated by remote sensing devices coupled to an electronic releasing panel which sends a signal activating the aerosol generator upon detection of a fire. Upon activation, the generators generate a quantity of an aerosol fire suppression agent which disperses into the enclosed volume and chemically interferes with fire propagating radicals thereby interrupting the fire reaction.

A conventional aerosol generator includes a casing which is mounted to a wall or other structure by means of a fixed bracket and includes discharge ports. To generate the aerosol fire suppression agent, a combustible aerosol-forming compound is arranged in the casing. The internal space downstream of the aerosol-forming compound, i.e., in the direction of discharge of the fire suppression agent from the casing, defines a combustion chamber which may be followed by structural elements which oxidize and/or cool the aerosol as it is discharged from the unit. Igniter material is arranged in connection with the aerosol-forming compound to cause combustion thereof and is ignited by receipt of an electronic signal from a releasing panel initiated by a remotely located sensor upon detection of a fire in the enclosed volume. Upon ignition of the igniter material, combustion of the aerosol-forming compound occurs resulting in dispersion of the aerosol fire suppression agent through the discharge ports in a manner known to those skilled in the art.

Aerosol generators are often incorporated into a system which includes fire-sensing devices spaced around the enclosed volume and a releasing panel which monitors the integrity of the system and activates the generators upon notification of a fire by means of a signal received from one or more of the fire-sensing devices. Instead of remote fire-sensing devices, some aerosol generators include a thermal sensor arranged directly on the generator. These are primarily used, however, for very small volumes such as within an electronic cabinet.

A drawback of fixedly mounting such aerosol generators is that they cannot be easily moved in a timely fashion to extinguish a fire at a different location from the mounting location. Thus, if an aerosol generator is arranged in one room of a facility and a fire is present in another room, the aerosol generator cannot be readily removed from the room without the fire, moved to the room with the fire and activated therein. In fact, removal of an aerosol generator from its mounting location for use at another location is not even worthwhile because most are electronically activated and therefore would not activate in a safe or timely manner if thrown into a fire. As such, conventional aerosol generators are not considered portable apparatus.

However, a portable aerosol generator is known, namely an aerosol fire extinguisher designated FP-1000M and sold by Celanova Ltd. under the tradename FirePro. This aerosol generator is manually activated by pulling a safety pin which results in immediate combustion of an aerosol-forming compound. This aerosol generator is susceptible to causing injury to users since it does not include a handle or other mechanism which allows for a time delay between pulling the safety pin and combustion of the aerosol-forming compound.

In addition, this portable aerosol generator only discharges the fire suppression agent from one end of the device. During expulsion of the fire suppression agent, the portable aerosol generator may be caused to move within the confined space where it has been activated. Such movement of the portable aerosol generator may cause the generator to be lodged between objects within the enclosed space which may occlude the generator discharge ports preventing expulsion of the fire suppression agent. As a result, a sufficient amount of fire suppression agent may not be expelled to extinguish the fire. In addition, the rapid expulsion of the fire suppression agent from one end of the generator might cause the generator to become self-propelled in such a way that it might exit the enclosed area (by being self-propelled out of a window or door) from which it was to extinguish the fire.

### OBJECTS AND SUMMARY OF THE INVENTION

It is an object of the present invention to provide a new and improved portable fire extinguisher, namely, a portable aerosol generator.

It is another object of the present invention to provide a new portable fire extinguisher which can be easily moved to a desired activation location, i.e., an enclosed volume with a fire therein, and manually activated when at that location.

It is yet another object of the present invention to provide a new portable fire extinguisher which can be safely thrown or otherwise introduced into a fire in an enclosed volume and activated upon being thrown or introduced to thereby generate a fire suppression agent which extinguishes the fire.

It is yet another object of the present invention to provide a new fire extinguisher which more readily and quickly expels fire suppression agent.

It is still another object of the present invention to provide a new method for extinguishing a fire using an aerosol generator.

In order to achieve these objects and others, an apparatus for extinguishing a fire in accordance with the invention includes a casing having an outer circumferential surface wherein the casing has a plurality of discharge ports disposed about the outer circumferential surface, an arrangement of material in the casing capable of generating an aerosol fire suppression agent which is discharged through the plurality of discharge ports, and an activation system which enables activation of the fire suppression agent.

The plurality of discharge ports fluidly couple an interior space of the casing where the aerosol fire suppression agent is maintained with the exterior of the casing so that the fire suppression agent can be expelled from the casing to extinguish the fire.

The materials for generating the fire suppression agent usually include an ignitable and combustible aerosol-forming compound. The generating arrangement also includes igniter material arranged in connection with the aerosol-forming compound and which is ignited by the manual activation system to cause ignition and combustion of the aerosol-forming compound.

The activation system may include a manually-activated firing pin which causes ignition of the igniter material upon contact therewith, a handle or other restraining member which normally restrains or prevents the firing pin from contacting the igniter material, and a manually releasable pull pin arranged to maintain the handle in a position in which the firing pin is prevented from contacting the igniter material. Upon release of the pull pin, the handle can be urged out of a position in which it prevents contact between the firing pin and the igniter material, with the result that the firing pin can be brought into contact with the igniter material, thereby causing generation of the fire suppression agent.

Movement of the firing pin from its restrained position into its contact position may be caused by a spring or other biasing mechanism which biases the firing pin against the handle and into contact with the igniter material. Thus, upon release of the pull pin, the spring causes the firing pin to displace the handle and continue its movement until it impacts the igniter material.

The pull pin and handle may be designed to cooperate such that the pull pin can be released only when a part of the handle is urged against the casing, to prevent inadvertent release of the pull pin resulting in unwanted activation of the apparatus.

A time delay between an initial activation stage of the manual activation system, i.e., when the pull pin is released, and subsequent activation of the fire suppression agent generation arrangement, i.e., ignition and combustion of the aerosol-forming compound, is provided to allow for the time needed between the time of actuation and introduction of the apparatus into a fire and the time for a person who actuates the apparatus to get to a safe distance from the fire. This time delay may be integrated or incorporated into the igniter material.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1 is a perspective view of a manually activated, portable fire-extinguishing aerosol generator in accordance with the invention.

FIG. 2 is a cross-sectional view of the aerosol generator shown in FIG. 1.

FIG. 3 is an enlarged view of the upper portion of the aerosol generator shown in FIG. 1 with the firing pin in an activation position.

### DETAILED DESCRIPTION OF THE INVENTION

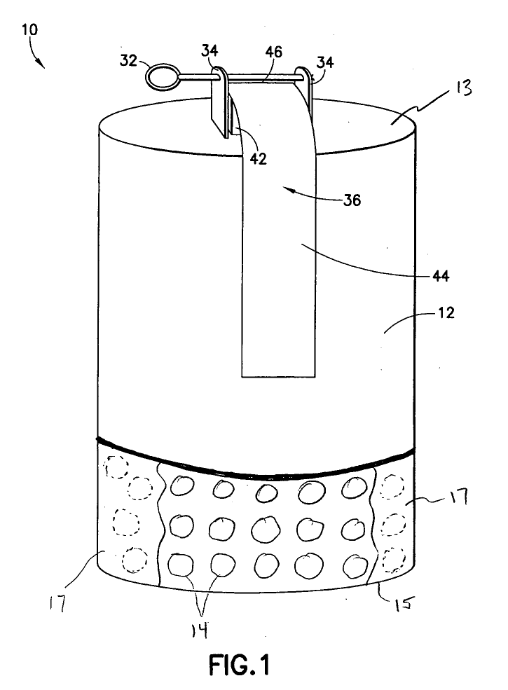

Referring to the accompanying drawings wherein like reference numbers refer to the same or similar objects, FIGS. 1-3 show a preferred embodiment of a manually activated, portable aerosol fire extinguisher in accordance with the invention which is designated generally as 10 and includes a substantially cylindrical casing 12 having a plurality of discharge ports 14 disposed from a first end 15 toward a second end 13 of the casing on the outer circumferential surface thereof. The plurality of discharge ports preferably extends about ⅕ to ¼ of the distance from the first end to the second end. It is foreseen, however, that the plurality of holes can extend 1/10 to ½ of the distance from the first end toward the second end, and even all of the way from the first end to the second end. While the casing is described as preferably being cylindrical (elongate), it is foreseen that other suitable shapes (cubic, spherical, pyramid among others) may be used.

The discharge ports 14 are disposed about the outer circumferential surface of the casing to enable a relatively quick, better and more complete discharge of fire suppression agent and to provide a large and robust cloud of fire suppression agent, as compared to prior art devices.

A spacer 11 is preferably provided proximate the wall of the casing 12 to separate (cushion) the inner contents of the extinguisher from the casing wall to prevent and brace the inner contents from moving inside the extinguisher 10. In the preferred embodiment the spacer is a ceramic cloth or wedge and the like which distances an aerosol-forming compound from the casing wall, but which will not burn when the extinguisher is activated.

Disposed about the outer circumferential surface of the casing is a sleeve 17 which is utilized to cover the discharge ports 14 to prevent debris from entering and clogging the discharge ports prior to use, to prevent moisture from entering the casing and compromising the operability of the igniter material and aerosol-forming compound, and to prevent the aerosol-forming compound from being expelled therefrom prior to activation. In a preferred embodiment of the present invention the sleeve comprises a metallic member such as a metallic tape disposed about the outer circumferential surface. A suitable magnetic tape 17 is Part No. 433L manufactured by 3M Corporation of St. Paul, Minn. It is foreseen, however, that any other covering which will permit expulsion of the fire suppression agent from the discharge ports upon activation of the generator, but which will not ignite due to the heat present during generation of the fire-suppression agent or when the device is placed proximate a fire, but which can prevent moisture, dirt and debris from entering and clogging the discharge ports can be employed.

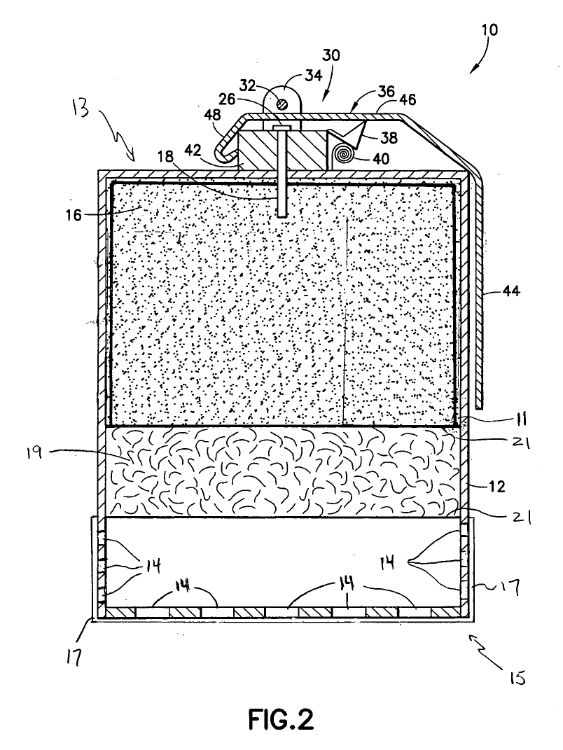

In casing 12, one or more materials capable of generating aerosol fire suppression agent to be discharged through the discharge ports 14 are provided. For example, as shown in FIG. 2, the casing 12 includes an aerosol-forming compound (pellet material) 16 arranged from the second end 13 of the extinguisher 10 toward the first end 15, along with a block of igniter material 18 which extends at least partially into the aerosol-forming compound 16. Igniter material 18 includes a primer 26 at its upper end. In the preferred embodiment, the aerosol-forming compound is a solid block of material or pellet material within the casing. The extinguisher includes a defuser layer 19 disposed between the aerosol-forming compound and the discharge ports. A suitable defuser material is pumice stone, alumina and the like. The defuser is included so that there is no possibility that the aerosol-forming compound will fall out of the casing through the discharge ports prior to ignition by the igniter material. A screen 21 is disposed between the aerosol-forming compound and the defuser material to maintain separation between these two regions prior to ignition, and at the bottom portion of the region which contains the defuser material. In the preferred embodiment, the defuser material does not extend to the region of the extinguisher where the discharge posts are located.

The manner in which the aerosol-forming compound is ignited by the igniter material 18 is known in the art. However, contrary to the teachings of the prior art which included oxidation and cooling blocks between the aerosol-forming compound and the discharge ports, it has been found that if the oxidation and cooling blocks are omitted, the aerosol-forming compound burns faster, the fire suppression agent is more readily expelled through the discharge ports and the fire is suppressed more quickly.

Casing 12 can be constructed with a variety of different sizes and fire suppression agent generating capacities, with the attendant different quantities of the aerosol-forming compound 16 and igniter material 18. The discharge ports 14 are preferably evenly distributed about the circumferential surface of the casing so as to disperse the aerosol fire suppression compound from all circumferential areas of the casing.

Suitable ignitable and combustible aerosol-forming compounds for use include those described in U.S. Pat. Nos. 5,831,209, 6,042,664, 6,264,772 and 6,689,285 (all of which are assigned to R-Amtech International, Inc. and incorporated by reference herein in their entirety).

In accordance with the invention, the aerosol fire extinguisher 10 includes a manual activation system 30 which requires a manual effort in order to cause ignition of the igniter material 18 resulting in generation of the fire suppression agent and its discharge through the discharge ports 14. By contrast, in prior art aerosol generators, ignition of the igniter material is performed automatically upon detection of a fire without any manual effort, or if manual effort is required, there is no time delay from activation to expulsion of the fire suppression agent.

The manual activation system 30 of the present invention includes a manually releasable pull pin 32 which is removably engaged with supports 34 arranged on the outer surface of the casing 12, a handle 36 which is maintained in a position on the casing 12 by the engagement of the pull pin 32 with the supports 34, and a firing pin 38 which is biased against the handle 36 by a spring 40. Pull pin 32 includes a pull ring and a safety cotter pin extending through the supports 34. The firing pin 38 is mounted on a mounting projection 42 on the axial wall of the casing 12 and biased to pivot about the mounting projection 42 into contact with the primer 26 of the igniter material 18. The impact of the firing pin 38 with the primer 26 causes ignition thereof and then ignition of the igniter material 18. However, handle 36 restrains firing pin 38 in that it prevents firing pin 38 from contacting the primer 26 when handle 36 is held in the position on the casing 12 by engagement of the pull pin 32 with the supports 34.

Handle 36 has a first part 44 arranged alongside a lateral wall of the casing 12, a second part 46 arranged above an axial wall of the casing 12 and over the mounting projection 42, and a third hook part 48 which engages with the mounting projection 42 (see FIG. 2). Instead of handle 36, other restraining members which restrain the firing pin 38 when the pull pin 32 is attached to the casing 12 while allowing pivotal movement of the firing pin 38 when the pull pin 32 is detached from the casing 12 can be provided.

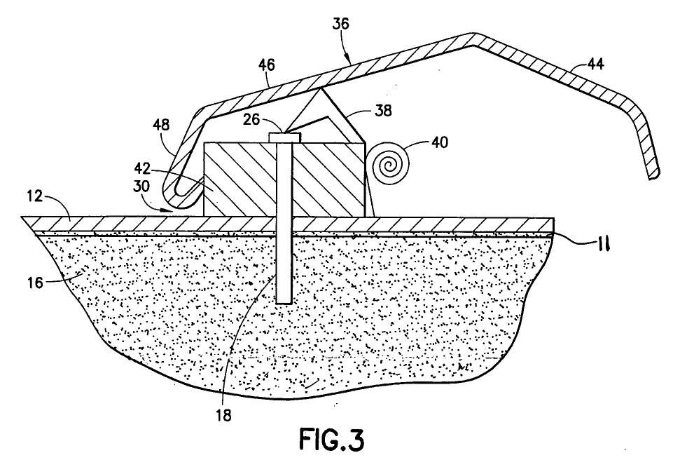

In use, upon removal of the pull pin 32 from engagement with the supports 34, the handle 36 can be urged out of its position restraining firing pin 38. The biasing force provided by spring 40 causes the firing pin 38 to pivot about the mounting projection 42 thereby forcing the handle 36 away from the casing 12 and out of a position in which it is preventing the firing pin 38 from contacting the primer 26. Upon continued pivoting movement, the firing pin 38 then impacts the primer 26 causing ignition of the igniter material 18 (see FIG. 3) which in turn causes combustion of the aerosol-forming compound 16 resulting in generation of the fire suppression agent and its discharge through discharge ports 14.

Thus, to extinguish a fire in an enclosed volume using aerosol fire extinguisher 10, the user would carry the portable aerosol fire extinguisher 10 to a site in close proximity to the enclosed volume, identify or create an access opening in or to the enclosed volume, e.g., open a door or window leading to the enclosed volume, remove the pull pin 32 from engagement with the supports 34 while holding the first part 44 of the handle 36 against the casing 12, and then introduce the portable aerosol fire extinguisher 10 into the enclosed volume, e.g., throw the fire extinguisher into a space where the fire is present. If possible, the access to the enclosed volume is blocked, i.e., close the door or window from which the fire extinguisher 10 was thrown. As the fire extinguisher is in its trajectory into the enclosed volume, the spring 40 causes the firing pin 38 to urge the handle 36 away from its position on the casing 12 (which is possible since the user is no longer maintaining the handle 36 against the casing 12) and urges the firing pin 38 to impact the primer 26 causing ignition of the igniter material 18. Ignition of the igniter material 18 causes combustion of the combustion material 16 leading to generation of the fire suppression agent and its discharge through the discharge ports 14. The casing 12 remains intact after all of the fire suppression agent has been generated and discharged through the discharge port 14. While it is preferred to use the invention in an enclosed area, the invention will suppress a fire even when the area is not completely enclosed if sufficient fire-extinguishing material is expelled as compared to the volume of the space and the size of the fire.

A time delay between the release of the handle 36 and discharge of the fire suppression agent may be provided by appropriate design and construction of, for example, the primer 26, the igniter material 18 and/or the aerosol-forming compound 16. Such a time delay is important to allow for the time needed between the time of actuation and introduction of the portable aerosol fire extinguisher 10 into the fire and time for the person who actuates the fire extinguisher 10 to get to a safe distance from the fire. The manner in which a time delay is provided via construction or composition of the igniter material 18 is known in the military grenade field.

The combination of the igniter material 18, primer 26, pull pin 32 and handle 36 can be considered the fuse of the aerosol fire extinguisher. An alternative fuse for use in the invention incorporates an additional safety mechanism to ensure adequate time to safely release the aerosol fire extinguisher 10, such as a sliding safety latch which must be moved prior to releasing the handle 36.

The pull pin 32 and handle 36 may be constructed to cooperate such that the pull pin 32 can be released only when the handle 36 is urged against the casing 12. This would prevent inadvertent release of the pull pin 32 and thus avoid unwanted activation of the aerosol fire extinguisher 10. Other variations in the manual activation system 30 are envisioned, for example, variations in the construction of the pull pin 32, handle 36, firing pin 38 and spring 40, and such variations may be derived from conventional grenade-type devices, such as munitions.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention. For example, although the described embodiments include only the aerosol forming compound and the defuser material, it is also possible to include at least one additional block of oxidation material and/or cooling material disposed between the aerosol-forming compound and the discharge ports. It is also envisioned that the igniter material 18 can extend substantially all of the way from the second end 13 of the casing to the opposite end of the aerosol-forming compound, thereby more uniformly igniting the aerosol-forming compound to concurrently disperse fire suppression agent through all of the discharge ports. In addition, while in the preferred embodiment the fire-extinguishing aerosol generator includes a manual activator, it is foreseen that a non-manual (automatic) activator could be employed, and that the casing having the plurality of discharge ports could be used in conjunction with any of the prior art fire-extinguishing aerosol generators. That is, a casing having the plurality of discharge ports about its outer circumferential surface could be employed with the wall mounted non-manually activated systems or with the manually-activated extinguishers of the prior art. While the device is described in the preferred embodiment as having a time delay after removal of pin 32, it is foreseen that the casing having the plurality of discharge ports can be employed in systems which do not include time delay mechanisms. It is also foreseen that in addition to the plurality of discharge ports being formed in the outer circumferential surface of the casing, the discharge ports can additionally be disposed on at least one of the end caps of the ends of the casing.

1. Apparatus for extinguishing a fire, comprising:
a casing having an outer circumferential surface, the casing having a plurality of discharge ports disposed about the outer circumferential surface;
an aerosol-forming generator arranged in said casing for generating an aerosol fire suppression agent and discharging the aerosol fire suppression agent through said plurality of discharge ports; and
a manual activator which enables manual activation of said aerosol-forming generator whereby said casing is introducible into the fire upon the manual activation of said aerosol-forming generator.

2. The apparatus of claim 1, wherein the casing is an elongated casing having first and second ends, and the plurality of discharge ports are formed from the first end toward the second end.

3. The apparatus of claim 1, wherein said manual activator includes a time delay between an initial activation stage of said manual activator and subsequent activation of said aerosol-forming generator.

4. The apparatus of claim 1, wherein said aerosol-forming generator comprises an aerosol-forming compound and igniter material arranged in connection with said aerosol-forming compound such that ignition of said igniter material causes combustion of said aerosol-forming compound thereby initiating generation of the aerosol fire suppression agent, said manual activator being arranged to ignite said igniter material.

5. The apparatus of claim 4, wherein said manual activator comprises a firing pin which causes ignition of said igniter material upon contact therewith, a restrainer which restrains said firing pin from contacting said igniter material and a manually releasable pull pin arranged to maintain said restrainer in a position in which said firing pin is prevented from contacting said igniter material, said pull pin being releasable to allow said restrainer to be urged out of said position such that said firing pin is then movable into contact with said igniter material.

6. The apparatus of claim 5, wherein said manual activator system further comprises a biasing device which biases said firing pin against said restrainer and into contact with said igniter material.

7. The apparatus of claim 6, wherein said biasing device comprises a spring.

8. The apparatus of claim 5, wherein said igniter material extends at least partially into said aerosol-forming compound.

9. The apparatus of claim 5, wherein said igniter material comprises a primer arranged at an end of said igniter material in a position to be contacted by said firing pin.

10. The apparatus of claim 5, further comprising a mounting projection arranged on said casing, said igniter material extending through said mounting projection and said firing pin being movably mounted to said mounting projection.

11. The apparatus of claim 5, wherein said restrainer comprises a handle having a first part arranged alongside a lateral wall of said casing and a second part arranged above an axial wall of said casing.

12. The apparatus of claim 1, wherein said aerosol-forming generator comprises aerosol-forming compounds.

13. Apparatus for extinguishing a fire, comprising:
a casing having an outer circumferential surface, the casing having a plurality of discharge ports disposed on the outer circumferential surface, and materials which generate an aerosol fire suppression agent which is discharged through said plurality of discharge ports; and
a manual activation system arranged to initiate generation of the aerosol fire suppression agent by said materials, said manual activation system including a manually releasable pull pin which allows generation of the aerosol fire suppression agent upon its release.

14. The apparatus of claim 13, wherein said materials include an aerosol-forming compound and an igniter material arranged in connection with said aerosol-forming compound such that ignition of said igniter material causes combustion of said aerosol-forming compound thereby initiating generation of the aerosol fire suppression agent, said manual activation system being arranged to ignite said igniter material.

15. The apparatus of claim 14, wherein said activation system further comprises a firing pin which causes ignition of said igniter material upon contact therewith and a handle for restraining said firing pin from contacting said igniter material, said pull pin being arranged to maintain said handle in a position in which said firing pin is prevented from contacting said igniter material and being releasable to allow said handle to be urged out of said position such that said firing pin is then movable into contact with said igniter material.

16. The apparatus of claim 15, further comprising a spring arranged to bias said firing pin against said handle and into contact with said igniter material.

17. The apparatus of claim 13, wherein said activation system includes a time delay to delay generation of the fire suppression agent after release of said pull pin.

18. A method for extinguishing a fire, comprising:
arranging materials which generate aerosol fire suppression agent in a casing having an outer circumferential surface, the casing having a plurality of discharge ports disposed in the outer circumferential surface through which the aerosol fire suppression agent is discharged from the casing, the materials including an aerosol-forming compound and igniter material in contact with the aerosol-forming compound;
biasing a firing pin into a position in which it contacts the igniter material to cause ignition thereof which in turns causes ignition and combustion of the aerosol-forming compound;
arranging a pull pin in a position in which it prevents contact between the firing pin and the igniter material;
in the presence of the fire, removing the pull pin from its position to thereby enable contact between the firing pin and the igniter material; and
introducing the casing into or proximate the fire, to cause discharge of the aerosol fire suppression agent.

19. The method of claim 18, further comprising:
positioning a handle to prevent contact between the firing pin and the igniter material; and
positioning the pull pin to restrain the handle on the casing.

20. The method of claim 18, further comprising integrating a time delay into the igniter material to delay ignition and combustion of the aerosol-forming compound after removal of the pull pin from its position.

21. Apparatus for extinguishing a fire, comprising:
a casing having an outer circumferential surface, the casing having a plurality of discharge ports disposed about the outer circumferential surface;
an aerosol-forming generator arranged in said casing for generating an aerosol fire suppression agent and discharging the aerosol fire suppression agent through said plurality of discharge ports; and
an activator which enables activation of said aerosol-forming generator.

22. The apparatus of claim 21, wherein the casing is an elongate casing having first and second ends and the plurality of discharge ports are formed from the first end toward the second end.
